(19) United States
(12) Patent Application Publication
(10) Pub. No.: US 2019/0065686 A1
(43) Pub. Date: Feb. 28, 2019

(54) MONITORING AND ASSESSING HEALTH RECORD DATA QUALITY

(71) Applicant: Scientific Technologies Corporation, Scottsdale, AZ (US)

(72) Inventors: Kristina Crane, Cave Creek, AZ (US); Brian Lee, Phoenix, AZ (US); Apoorv Sharma, Tempe, AZ (US); Karen Chin, Anchorage, AK (US); Marty Ulrich, Mesa, AZ (US)

(73) Assignee: Scientific Technologies Corporation, Scottsdale, AZ (US)

(21) Appl. No.: 15/693,303

(22) Filed: Aug. 31, 2017

(51) Int. Cl. G06F 19/00

(52) U.S. Cl. CPC G06F 19/322

(57) ABSTRACT

Systems, methods, and articles of manufacture for monitoring and assessing health record data quality are disclosed. The system monitors and assesses health record data quality in an on-boarding environment and/or a production environment. The system ingests health record data transmitted by various health record data sources. The system monitors the ingestion of health record data to detect data quality errors occurring during the ingestion. Based on the data quality errors, and in response to detecting one or more data quality errors, the system generates a data quality score that can be used to determine the overall quality of data being ingested into the system.

### FIELD

The disclosure generally relates to electronic health records, and more specifically, to systems and methods for monitoring and assessing the quality of health record data.

### BACKGROUND

Electronic immunization records, health records, or other such data may be received in a central repository. The central repository may receive data from hundreds of data sources with each data source transmitting hundreds of thousands of records. For example, the central repository may receive data from state data sources, healthcare providers, or other suitable sources. As such, data may be received having varying data quality and formatting. Due partially to the volume of data being transferred, the various data sources may not be aware of quality and formatting problems in the transmitted data. Data quality and formatting problems may partially limit the ability of the central repository to accurately identify the data, which may partially reduce the accuracy, consistency, and completeness of patient records in the central repository.

Immunization levels in the United States are below targeted levels desirable to minimize the incidence of vaccine preventable disease. Additionally, immunization programs typically result in cost savings of 500% or more in direct medical costs as compared to immunization expenses. Accordingly, improved systems and methods for ensuring the accuracy, consistency, and completeness of health records received into the central repository, including immunization records, are desirable.

### SUMMARY

In various embodiments, systems, methods, and articles of manufacture (collectively, “the system”) for monitoring and assessing health record data quality are disclosed. The system may provide an automated assessment of the quality of health record data that is being received into a health record management system. For example, the system may assess the quality of health record data by detecting data quality errors occurring when the health record data is processed by the health record management system. The system may provide feedback on the quality of health record data to the data sources. The feedback may allow each data source to fix the data quality errors and other such quality problems in the transmitted health record data. In that respect, the overall quality of health record data stored in the health record management system may be improved to ensure that the stored health record data is accurate, consistent, and complete.

In various embodiments, the system may receive an on-boarding request comprising a data quality user threshold and a health record data source. The system may ingest health record data from the health record data source. The system may monitor the ingestion of health record data and detect a data quality error occurring during the ingestion of health record data. The system may generate a data quality score based on the data quality error.

In various embodiments, the system may also compare the data quality score with the data quality user threshold. The system may generate a data analytics report based on at least one of the data quality error or the data quality score. The data quality error may comprise at least one of a data validation error or a data formatting error. The data validation error may be detected by comparing a first data field of the health record data to a second data field of the health record data based on a validation logic. The health record data source may comprise at least one of a state health record data source or a healthcare provider system. The health record data may comprise immunization records formatted according to Health Level 7 (HL7) messaging requirements.

In various embodiments, the system may monitor, in a production environment, an ingestion of health record data from a health record data source. The system may detect a data quality error occurring during the ingestion of health record data. The system may generate a data quality score based on the data quality error.

In various embodiments, the system may compare the data quality score to a data quality user threshold. The system may generate a data quality alert in response to the data quality score being less than the data quality user threshold.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is a block diagram illustrating various system components of a system for monitoring and assessing health record data quality, in accordance with various embodiments;

FIG. 2 is a block diagram illustrating various sub-system components of a data quality system for an exemplary system for monitoring and assessing health record data quality, in accordance with various embodiments;

FIG. 3 illustrates a process flow for a method of monitoring and assessing health record data quality in an on-boarding environment, in accordance with various embodiments;

FIG. 4 illustrates a process flow for a method of monitoring and assessing health record data quality in a production environment, in accordance with various embodiments;

FIG. 5A illustrates an exemplary on-boarding screen layout of an exemplary data quality system, in accordance with various embodiments;

FIG. 5B illustrates an exemplary data quality error report in an exemplary data quality system, in accordance with various embodiments; and

FIG. 5C illustrates an exemplary data analytics report in an exemplary data quality system, in accordance with various embodiments.

### DETAILED DESCRIPTION

The detailed description of exemplary embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and/or functional changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

As used herein, “electronic communication” means communication of electronic signals with physical coupling (e.g., “electrical communication” or “electrically coupled”) or without physical coupling and via an electromagnetic field (e.g., “inductive communication” or “inductively coupled” or “inductive coupling”). As used herein, “transmit” may include sending electronic data from one system component to another over a network connection. Additionally, as used herein, “data” may include encompassing information such as commands, queries, files, data for storage, and the like in digital or any other form.

As used herein, “meet,” “match,” “associated with,” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present disclosure provides a system, method, and article of manufacture (collectively, “the system”) for monitoring and assessing health record data quality. The system may provide an automated assessment of the quality of health record data that is being received into a health record management system. For example, the system may assess the quality of health record data by detecting data quality errors occurring when the health record data is processed by the health record management system. The system may provide feedback on the quality of health record data to the data sources. The feedback may allow each data source to fix the data quality errors and other such quality problems in the transmitted health record data. In that respect, the overall quality of health record data stored in the health record management system may be improved to ensure that the stored health record data is accurate, consistent, and complete.

For example, the system may ingest health records from various data sources, including from state health records and healthcare providers. The system may monitor the ingestion of health records to detect data quality errors. In response to detecting the data quality errors, the system may perform various data analytic operations on the detected data quality errors, as discussed further herein. In response to detecting the data quality errors, the system may also generate data quality reports comprising information about the data quality errors and/or the data quality analytics. The system may offer a production environment and an on-boarding environment. In the on-boarding environment, the system may allow state health record data sources, healthcare provider systems, or the like to test the data quality of transmitted data sources prior to entering the production environment. The system may partially reduce the storage of incorrect or incomplete data by detecting and reporting data quality errors, thus partially ensuring accurate, consistent, and complete data records.

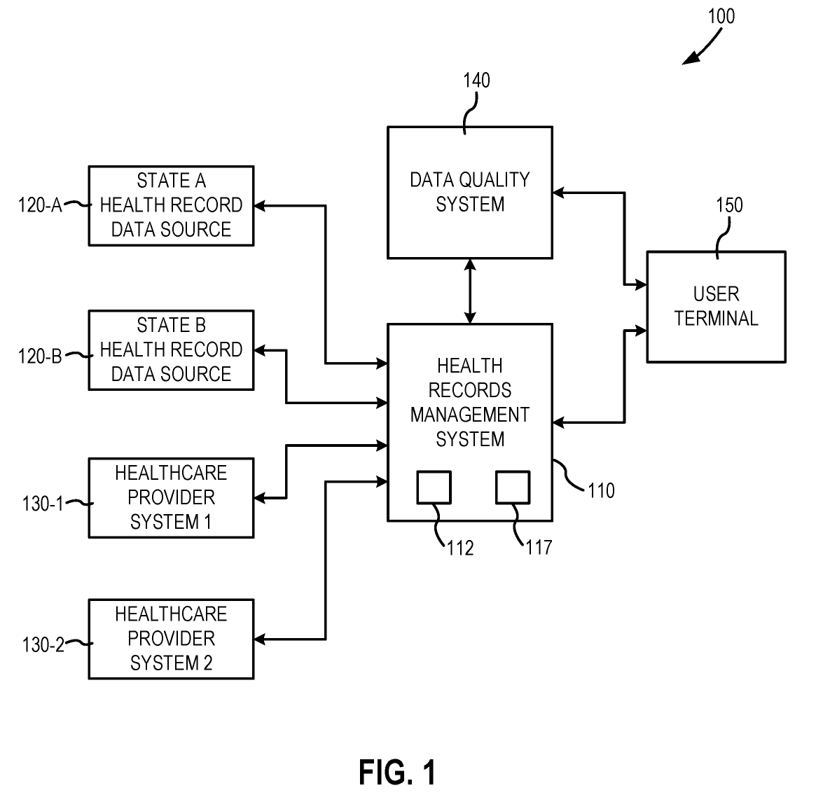

The system further improves the functioning of the computer or server (e.g., health records management system, with brief reference to FIG. 1). For example, monitoring, assessing, and reporting data quality errors may partially increase the ability of the health records management system to produce more accurate data aggregations, and may also partially increase the accuracy, consistency, and completeness in the health record data stored in the system. Furthermore, by automating the monitoring, assessing, and reporting of data quality errors as opposed to needing the user to manually monitor, assess, and report data quality errors, the user performs less computer functions and provides less input, which saves on data storage and memory, thus speeding processing in the computer or server. Moreover, by partially reducing the need for user input, the speed of monitoring, assessing, and reporting data quality errors may be increased. Additionally, by transmitting, storing, and accessing data using the processes described herein, the security of the data is improved, which decreases the risk of the computer or network, or the data itself (including confidential data) from being compromised.

While the foregoing makes reference to health record data, immunization records, and/or similar such data, it should be recognized by one skilled in the art that the present disclosure may extend to any suitable data processing system wherein monitoring and assessing the quality of data may be desired.

In various embodiments, and with reference to FIG. 1, a system 100 for monitoring and assessing health record data quality is disclosed. System 100 may be computer based, and may comprise a processor, a tangible non-transitory computer-readable memory, and/or a network interface, along with other suitable system software and hardware components. Instructions stored on the tangible non-transitory memory may allow system 100 to perform various functions, as described herein. System 100 may also contemplate uses in association with web services, utility computing, pervasive and individualized computing, security and identity solutions, autonomic computing, cloud computing, commodity computing, mobility and wireless solutions, open source, biometrics, grid computing and/or mesh computing.

In various embodiments, system 100 may comprise various systems, engines, modules, databases, and components with different roles. The various systems, engines, modules, databases and components described herein may be in direct logical communication with each other via a bus, network, and/or through any other suitable logical interconnection permitting communication amongst the various systems, engines, modules, databases and components, or may be individually connected as described further herein. More specifically, and in accordance with various embodiments, system 100 may comprise one or more of a health records management system 110, a state health record data source (e.g., state A health record data source 120-A, state B health record data source 120-B, or the like), a health care provider system (e.g., healthcare provider system 130-1, healthcare provider system 130-2, or the like), a data quality system 140, and/or a user terminal 150.

In various embodiments, health records management system 110 may be in electronic and/or logical communication with one or more state health record data sources (e.g., state A health record data source 120-A, state B health record data source 120-B, or the like), one or more healthcare provider systems (e.g., healthcare provider system 130-1, healthcare provider system 130-2, or the like), data quality system 140, and/or user terminal 150. Health records management system 110 may be configured to facilitate storage and/or transmission of health record data, such as, for example, immunization record data. Health records management system 110 may be configured to provide a centralized repository for access to vaccine administration records, reminders, vaccination reports, vaccine inventory levels, demand forecasts, or the like. For example, health records management system 110 may be configured to receive health record data from state health record data sources, healthcare provider systems, or the like; parse the health record data to determine the data in the health record data and to detect data quality errors; edit, map, and format the health record data for storage; and store and maintain the health record data in any suitable database (e.g., a health record database), using any suitable technique described herein. Health records management system 110 may comprise any suitable health records management system, such as, for example, the health records management system disclosed in U.S. Ser. No. 14/036,476 titled HEALTH RECORDS MANAGEMENT SYSTEMS AND METHODS and filed on Sep. 25, 2013, the contents of which are herein incorporated by reference in its entirety.

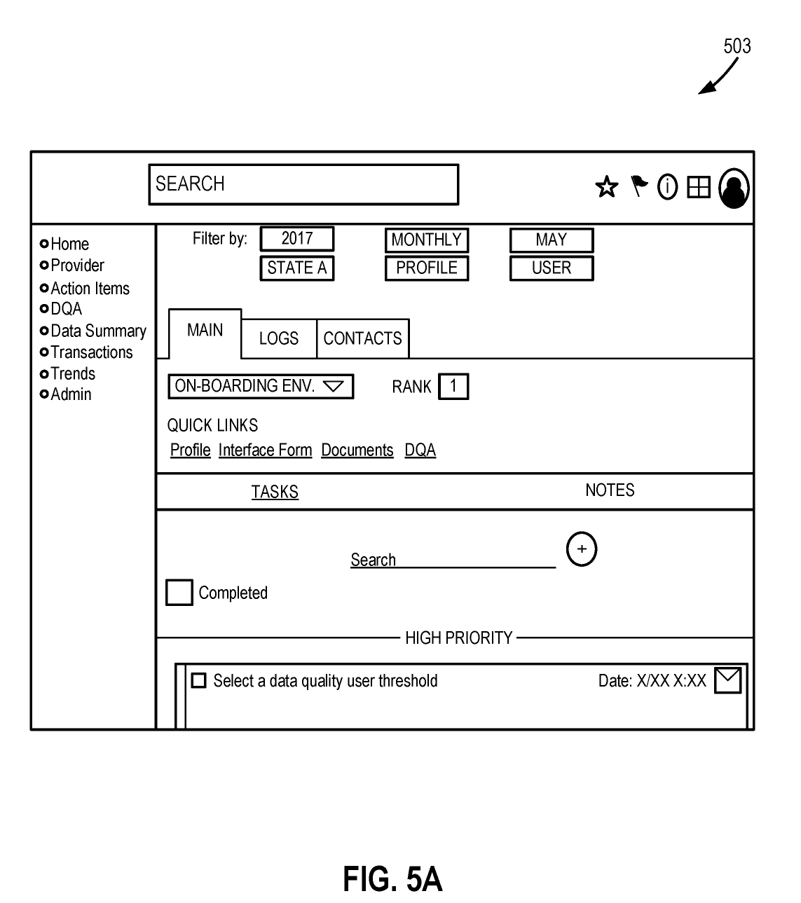

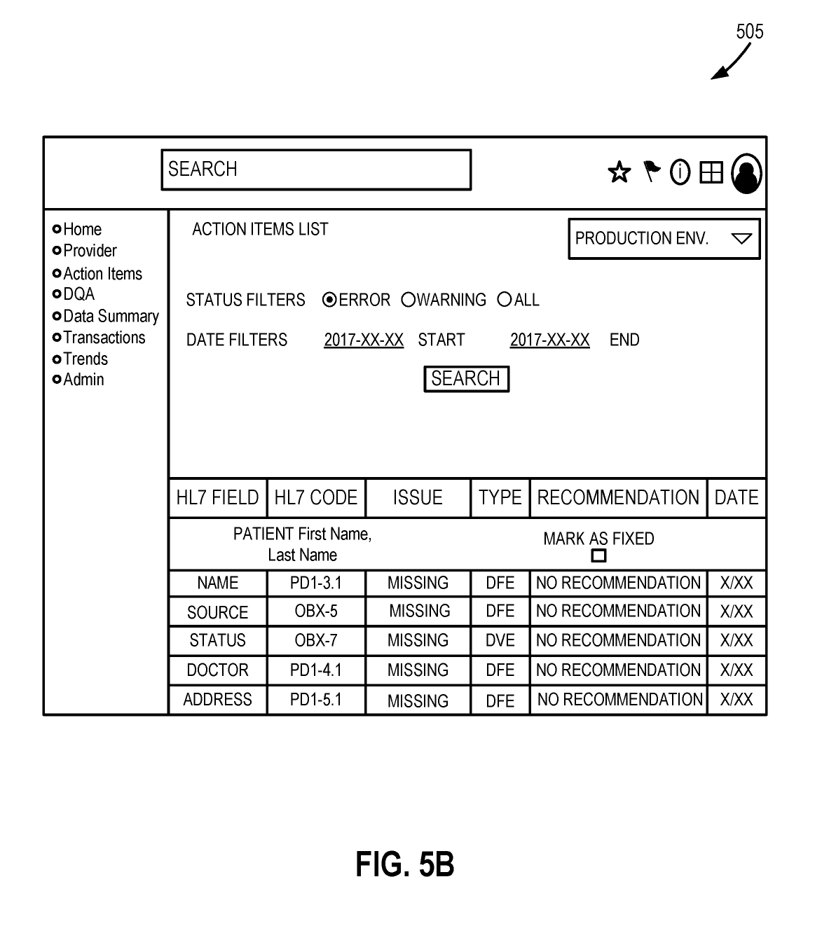

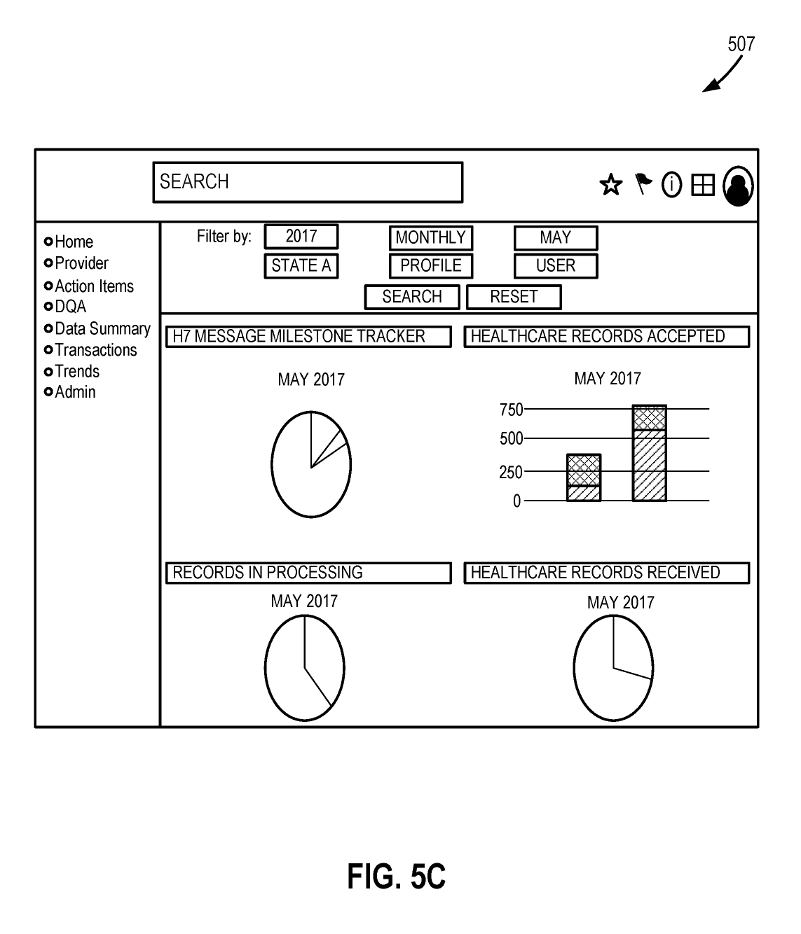

Health records management system 110 may include a user interface (“UI”), software modules, logic engines, various databases, interfaces to systems and tools, and/or computer networks. While exemplary health records management systems may contemplate upgrades or reconfigurations of existing processes and/or systems, changes to existing databases and system tools are not necessarily required by principles of the present disclosure. Health records management system 110 may comprise an on-boarding environment 112 and a production environment 117. On-boarding environment 112 and production environment 117 may comprise logical partitions configured to allow a user, via user terminal 150, to interact with health records management system 110. For example, a user may interact with on-boarding environment 112 to establish a connection between data sources, provider systems, or the like, and on-boarding environment to test the transmission of data and to establish a baseline of the health record data quality being transmitted, as discussed further herein. For example, in accordance with various embodiments and with brief reference to FIG. 5A, a user may interact with an on-boarding GUI 503 to facilitate setting up an on-boarding process and selecting a data quality user threshold.

With reference again to FIG. 1, a user may interact with production environment 117 to begin the transmission and storage of health record data. For example, a user may interact with production environment 117 after the baseline of health record data quality is established (e.g., to ensure that health record data being transmitted, stored, and maintained in health records management system 110 is of a sufficient data quality). In that regard, in production environment 117, the health record data is ingested, parsed, edited, mapped, and/or stored into health records management system 110.

In various embodiments, system 100 may comprise one or more state health record data sources, such as, for example, a state A health record data source 120-A, a state B health record data source 120-B, and/or the like. System 100 may also comprise one or more healthcare provider systems, such as, for example, a healthcare provider system 130-1, a healthcare provider system 130-2, or the like. Each of the state health record data sources 120 and/or the healthcare provider systems 130 may be in electronic and/or logical communication with health records management system 110. Each of the state health record data sources 120 and/or the healthcare provider systems 130 may be configured to transit health record data to health records management system 110. State health record data sources 120 may comprise any suitable source for health record data, but in various embodiments, the data source is the participating state(s) immunization information system or “registry.” The health record data may include health records (e.g., patient information, provider information, medical procedure information, clinical information, diagnostic information, immunization records, prescription information, family information, genetic information, and/or the like), or any other suitable information discussed herein.

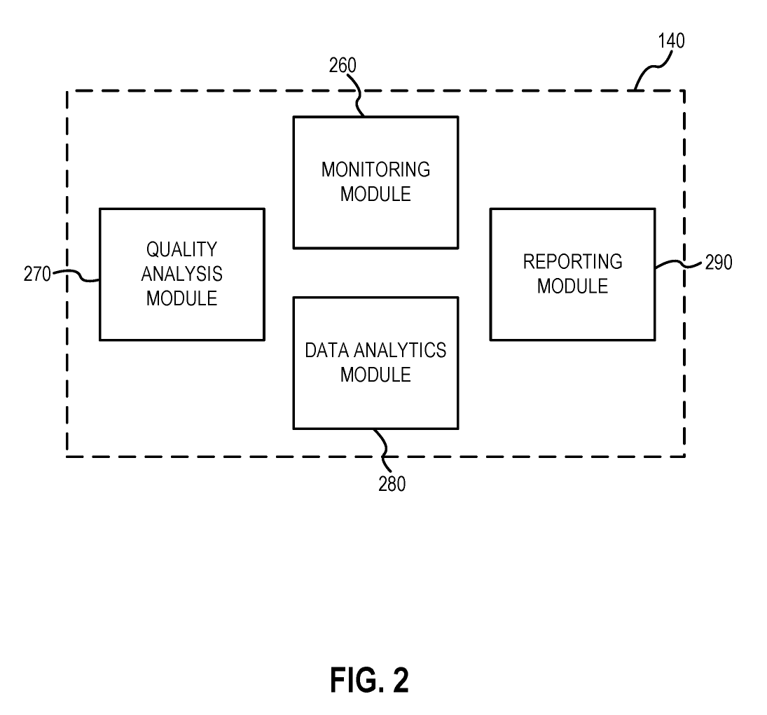

In various embodiments, data quality system 140 may be in electronic and/or logical communication with health records management system 110. Data quality system 140 may be configured to monitor the ingestion, parsing, editing, mapping, and/or storage of data (e.g., health record data) into health records management system 110. For example, data quality system 140 may be configured to monitor the ingestion of data to detect, track, and report data quality errors, as discussed further herein. Data quality system 140 may include a user interface (“UI”), software modules, logic engines, various databases, interfaces to systems and tools, and/or computer networks. In various embodiments, and with reference to FIG. 2, data quality system 140 may comprise one or more modules configured to aid in monitoring the ingestion of data. For example, data quality system 140 may comprise one or more of a monitoring module 260, a quality analysis module 270, a data analytics module 280, and/or a reporting module 290.

In various embodiments, monitoring module 260 may be configured to monitor the ingestion of data into health records management system 110. Monitoring module 260 may monitor the ingestion of health record data to determine whether each received health record data causes a data quality error, as described further herein. In that respect, monitoring module 260 may track the data quality errors to determine the number of ingested health record data that are causing data quality errors and/or the number of ingested health record data that are not causing data quality errors. In various embodiments monitoring module 260 may also track the type of data quality error that is occurring (e.g., data validation errors or data formatting errors, as discussed further herein).

In various embodiments, quality analysis module 270 may be configured to track and provide analysis of the data quality errors detected by monitoring module 260. For example quality analysis module 270 may be configured to generate a data quality score. The data quality score may reflect the number of health data records ingested by health records management system 110 that comprise data quality errors, in comparison to the number of health data records ingest that do not comprise data quality errors, as discussed further herein. Quality analysis module 270 may be configured to compare the data quality score to a data quality user threshold. Quality analysis module 270 may compare the data quality score to the data quality user threshold to determine whether the data quality score is greater than or less than the data quality user threshold. In that respect, a data quality score being greater than the data quality user threshold may indicate that the quality of health data record being ingested by system 100 may be greater than the threshold of quality set by the user. A data quality score being less than the data quality user threshold may indicate that the quality of health data record being ingested by system 100 is not meeting the threshold of quality set by the user.

In various embodiments, data analytics module 280 may be configured to generate a data analytics report. Data analytics module 280 may be configured with analytics capabilities to allow users (e.g., state representatives of the like) to visualize trending, provider referral details, and otherwise analyze the quality of health data records. Data analytics module 280 may also comprise and/or be configured with forecasting tools, for example in order to evaluate potential future immunization needs or other modeled public health requirements or outcomes related to the quality of the health data records being transmitted. For example, and with brief reference to FIG. 5C, an exemplary GUI 507 showing reported data analytics is depicted.

In various embodiments, and with reference again to FIG. 2, reporting module 290 may be configured to transmit data to user terminal 150, and/or generate one or more reports, alerts, or the like. For example, reporting module 290 may be configured to transmit the data quality score to user terminal 150. Reporting module 290 may also be configured to transmit the total number of data quality errors, the number of data validation errors and/or data formatting error, or similar such data. Reporting module 290 may transmit the data using any suitable messaging platform, such as email systems, wireless communications systems, mobile communications systems, multimedia messaging service (“MMS”) systems, short messaging service (“SMS”) systems, and the like. Reporting module 290 may also transmit the data by displaying the data, via a GUI, webpage, or the like, for viewing by the user on user terminal 150. For example, and with brief reference to FIG. 5B, an exemplary GUI 505 showing reported data quality errors is depicted. Reporting module 290 may also be configured to generate a data quality alert in response to the data quality score being less than the data quality user threshold.

In various embodiments, and with reference again to FIG. 1, user terminal 150 may be in electronic and/or logical communication with health records management system 110 and/or data quality system 140. User terminal 150 may include any device (e.g., a computer, smart phone, tablet, etc.), which communicates, in any manner discussed herein, with health records management system 110 and/or data quality system 140 via any network or protocol discussed herein. Browser applications comprise internet browsing software installed within a computing unit or system to conduct online communications and transactions. These computing units or systems may take the form of personal computers, mobile phones, personal digital assistants, mobile email devices, laptops, notebooks, hand-held computers, portable computers, kiosks, and/or the like. Practitioners will appreciate that user terminal 150 may or may not be in direct contact with health records management system 110 and/or data quality system 140. For example, user terminal 150 may access the services of health records management system 11 through another server, which may have a direct or indirect connection to an internet server. Practitioners will further recognize that user terminal 150 may present interfaces associated with a software application or module that are provided to user terminal 150 via application graphical user interfaces (GUIs) or other interfaces and are not necessarily associated with or dependent upon internet browsers or internet specific protocols (e.g., as depicted in FIGS. 5A-5C). In that regard, a user may interact with user terminal 150 to transmit and receive data, reports, alerts, and the like, as discussed further herein.

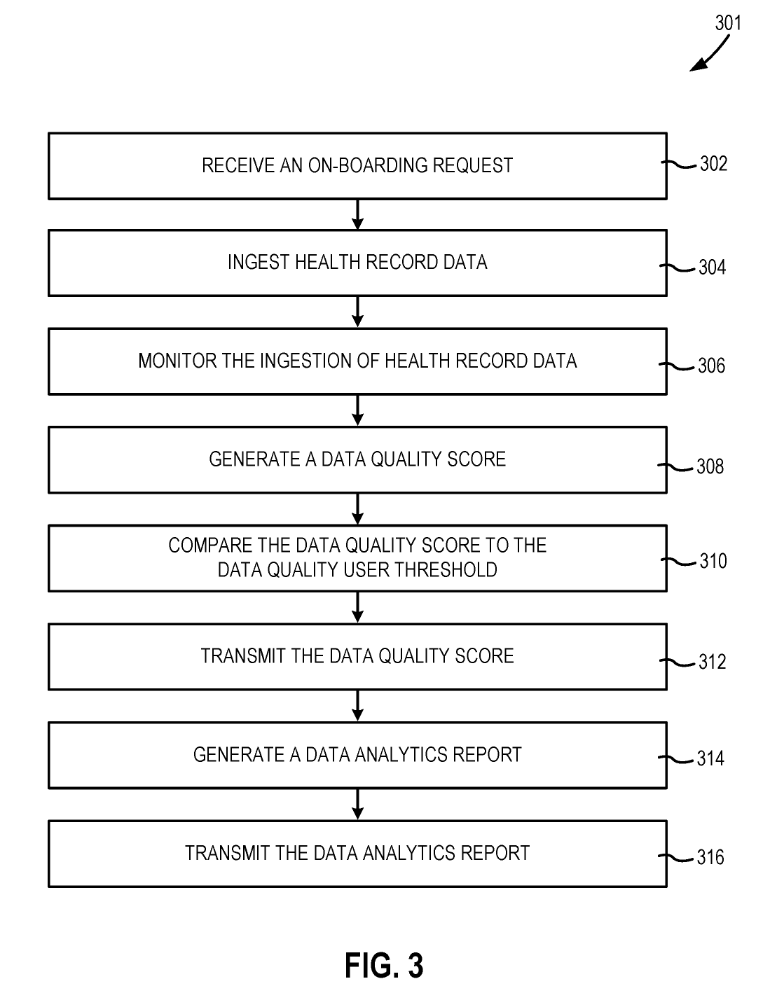

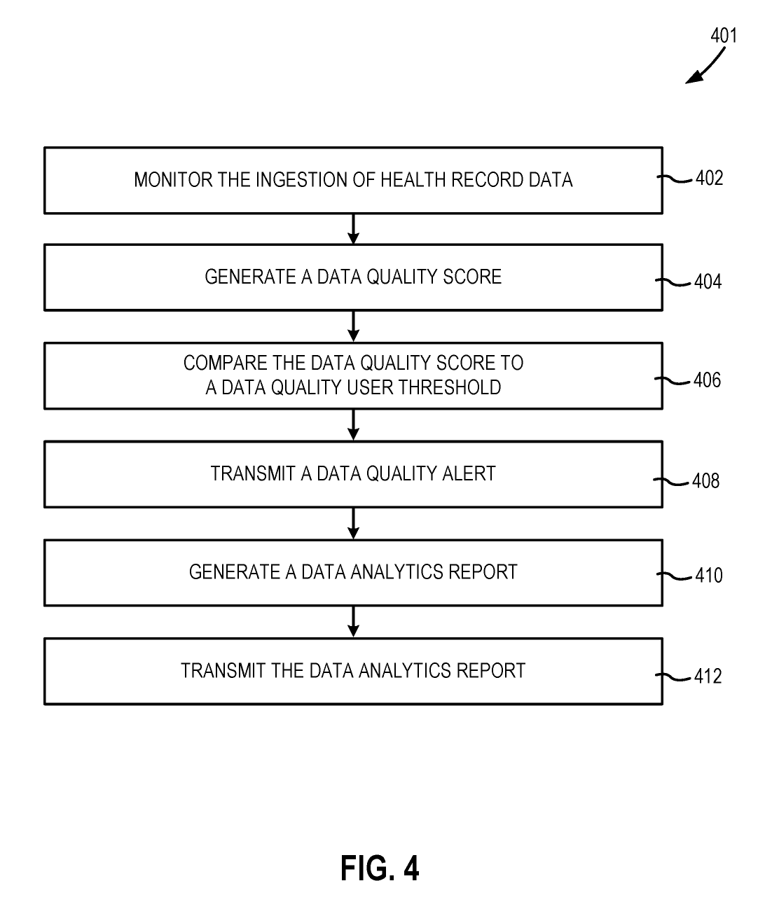

Referring now to FIGS. 3 and 4, the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and elements depicted in FIGS. 3 and 4, but also to the various system components as described above with reference to FIGS. 1 and 2.

In various embodiments, and with specific reference to FIG. 3, a method 301 for monitoring and assessing health record data in an on-boarding environment is disclosed. Method 301 may comprise receiving an on-boarding request (step 302). Health records management system 110 may be configured to receive the on-boarding request from user terminal 150. For example, a user may interact via user terminal 150 with a GUI, webpage, or the like on health records management system 110 to configure and transmit the on-boarding request. For example, and with brief reference to FIG. 5A, an exemplary on-boarding GUI 503 for an on-boarding process is depicted. The on-boarding request may specify the data source (e.g., state A health record data source 120-A, state B health record data source 120-B, etc.), provider system (e.g., healthcare provider system 130-1, healthcare provider system 130-2, etc.), or the like from which to establish a communication to begin receiving health record data. The on-boarding request may also specify a data quality user threshold. The data quality user threshold may comprise data indicating a desired or suitable threshold of received data that is determined to comprise data quality errors. For example, the data quality user threshold may specify that at least 90% of health record data received in health records management system 110 should be ingested without triggering a data quality error, or any other suitable percentage, ratio, or the like. Health records management system 110 may transmit the data quality user threshold to data quality system 140. In various embodiments, data quality system 140 may also be configured to receive the data quality user threshold directly from user terminal 150. In response to receiving the on-boarding request, health records management system 110 may establish a connection between on-boarding environment 112 and the specified data source, provider system, or the like. In on-boarding environment 112, the health record data may not be stored (e.g., in comparison to production environment 117). For example, users may desire to test their data record transmission process in on-boarding environment 112 before entering into production environment 117.

In various embodiments, method 301 may comprise ingesting health record data (step 304). In response to establishing a connection between on-boarding environment 112 and the specified data source, provider system, or the like, health records management system 110, via on-boarding environment 112, may receive health record data. Health records management system 110 may receive the health record data individually, in batch files, or through any other suitable or desired format. The health record data may include health records (e.g., patient information, provider information, medical procedure information, clinical information, diagnostic information, immunization records, prescription information, family information, genetic information, and/or the like), or any other suitable information discussed herein. The health record data may comprise any suitable format, such as, for example, formatting required by Health Level 7 (HL7) messaging capabilities, state-specific or state-required guidelines, or the like.

In response to receiving the health record data, health records management system 110 may perform operations and transformation on the health record data to prepare the data for storage. For example, health records management system 110 may parse the health record data to detect data quality errors. The data quality errors may comprise a data validation error or a data formatting error. The data validation error may comprise errors relating to the data in one or more health record data. For example, health records management system 110 may comprise validation logic to determine whether the health record data comprises a data validation error. The validation logic may be used to detect logical inconsistencies in one or more health record data. For example, the validation logic may determine values in one or more data fields of the health record data, and cross-check the data to determine any logical inconsistencies. Examples of logical inconsistencies may include comparing a vaccination record with an individual's age (e.g., a measles, mumps, and rubella (MMR) vaccination is not given to a person 80-years-old), or the like. The data formatting error may comprise errors relating to the formatting of data in one or more health record data. For example, data formatting errors may comprise errors relating to missing data fields, grammatical errors, abbreviation errors (e.g., “street” vs. “st,” etc.), logical formatting errors (e.g., numerical values in name fields), or the like. Other errors that can be detected include missing data elements that should have been shared or incorrect codes, such as CVX codes which may have been sent for a vaccine based on specific patient indicators.

In various embodiments, method 301 may comprise monitoring the ingestion of the health record data (step 306). Data quality system 140 may be configured to monitor the ingestion of health record data in health records management system 110. For example, monitoring module 260 of data quality system 140 may be configured to monitor the ingestion of health record data in health records management system 110. Data quality system 140 may monitor the ingestion of health record data to determine whether each received health record data comprises a data quality error, as described further above. In that respect, data quality system 140 may track the data quality errors to determine the number of ingested health record data that are causing data quality errors and/or the number of ingested health record data that are not causing data quality errors. In various embodiments, data quality system 140 may also track the type of data quality error that is occurring (e.g., data validation errors or data formatting errors).

In various embodiments, method 301 may comprise generating a data quality score (step 308). Data quality system 140 may be configured to generate the data quality score. For example, quality analysis module 270 of data quality system 140 may be configured to generate the data quality score. The data quality score may reflect the number of health record data ingested by health records management system 110 that comprise data quality errors, in comparison to the number of health record data ingest that do not comprise data quality errors. For example, in response to ingesting 900 health record data that cause no data quality errors and 100 health record data that cause data quality errors, data quality system 140 may generate a data quality score of 90%, or the like. The data quality score may comprise any suitable numerical, alpha-numerical, and/or similar such rating scale. In various embodiments, the data quality score may comprise the same rating scale as the data quality user threshold.

In various embodiments, method 301 may comprise comparing the data quality score to the data quality user threshold (step 310). Data quality system 140 may be configured to compare the data quality score to the data quality user threshold. For example, quality analysis module 270 of data quality system 140 may be configured to compare the data quality score to the data quality user threshold. Data quality system 140 may compare the data quality score to the data quality user threshold to determine whether the data quality score is greater than or less than the data quality user threshold. In that respect, a data quality score being greater than the data quality user threshold may indicate that the quality of health record data being ingested by system 100 may be greater than the threshold of quality set by the user in step 302. A data quality score being less than the data quality user threshold may indicate that the quality of health record data being ingested by system 100 is not meeting the threshold of quality set by the user in step 302. In various embodiments wherein the data quality score and the data quality user threshold comprise different rating scales, data quality system 140 may be configured to convert the data quality score and/or the data quality user threshold to a common rating scale prior to the step of comparing.

Method 301 may comprise transmitting the data quality score (step 312). Data quality system 140 may be configured to transmit the data quality score to user terminal 150. For example, reporting module 290 of data quality system 140 may be configured to transmit the data quality score to user terminal 150. In that regard, the data quality score may provide a feedback mechanism wherein the user, via user terminal 150, may determine whether the health record data being sent to on-boarding environment 112 is meeting quality expectations established in the data quality user threshold. In various embodiments, data quality system 140 may also be configured to transmit the total number of data quality errors, the number of data validation errors and/or data formatting error, or similar such data. Data quality system 140 may transmit the data in response to a user request, or may transmit the data based on a processing schedule (e.g., daily, weekly, monthly, etc.). Data quality system 140 may transmit the data using any suitable messaging platform, such as email systems, wireless communications systems, mobile communications systems, multimedia messaging service (“MMS”) systems, short messaging service (“SMS”) systems, and the like. Data quality system 140 may also transmit the data by displaying the data, via a GUI, webpage, or the like, for viewing by the user on user terminal 150. For example, and with brief reference to FIG. 5B, an exemplary GUI 505 showing reported data quality errors is depicted.

In various embodiments, method 301 may comprise generating a data analytics report (step 314). Data quality system 140 may be configured to generate the data analytics report. For example, data analytics module 280 of data quality system 140 may be configured to generate the data analytics report. In that regard, data analytics module 280 may be configured with analytics capabilities to allow users (e.g., state representatives of the like) to visualize trending, provider referral details, and otherwise analyze the quality of health record data. Data analytics module 280 may also comprise and/or be configured with forecasting tools, for example in order to evaluate potential future immunization needs or other modeled public health requirements or outcomes related to the quality of the health record data being transmitted. Method 301 may comprise transmitting the data analytics report (step 316). Data quality system 140 may be configured to transmit the data analytics report to user terminal 150. For example, data analytics module 280 of data quality system 140 may be configured to transmit the data analytics report to user terminal 150. Data quality system 140 may transmit the data in response to a user request, or may transmit the data based on a processing schedule (e.g., daily, weekly, monthly, etc.). Data quality system 140 may transmit the data using any suitable messaging platform, such as email systems, wireless communications systems, mobile communications systems, multimedia messaging service (“MMS”) systems, short messaging service (“SMS”) systems, and the like. Data quality system 140 may also transmit the data by displaying the data, via a GUI, webpage, or the like, for viewing by the user on user terminal 150. For example, and with brief reference to FIG. 5C, an exemplary GUI 507 showing reported data analytics is depicted.

In various embodiments, and with specific reference to FIG. 4, a method 401 for monitoring and assessing health record data in a production environment is disclosed. For example, a user may desire to interact with production environment 117 to transmit and store health record data. In that respect, the user may first interact with on-boarding environment 112, as discussed in method 301, to ensure that the health record data are being properly transmitted and stored at a desired quality, prior to interacting with production environment 117. For example, a user, via user terminal 150 may interact with health records management system 110 and/or data quality system 140 to specify the data source (e.g., state A health record data source 120-A, state B health record data source 120-B, etc.), provider system (e.g., healthcare provider system 130-1, healthcare provider system 130-2, etc.), or the like from which to establish a communication to begin receiving health record data into production environment 117. Health records management system 110 may receive the health record data individually, in batch files, or through any other suitable or desired format. The health record data may include health records (e.g., patient information, provider information, medical procedure information, clinical information, diagnostic information, immunization records, prescription information, family information, genetic information, and/or the like), or any other suitable information discussed herein. The health record data may comprise any suitable format, such as, for example, formatting required by Health Level 7 (HL7) messaging capabilities, state-specific or state-required guidelines, or the like.

In response to receiving the health record data, health records management system 110 may perform operations and transformation on the health record data to prepare the data for storage. For example, health records management system 110 may parse the health record data to detect data quality errors. The data quality errors may comprise a data validation error or a data formatting error. The data validation error may comprise errors relating to the data in one or more health record data. For example, health records management system 110 may comprise validation logic to determine whether the health record data comprises a data validation error. The validation logic may be used to detect logical inconsistencies in one or more health record data. For example, the validation logic may determine values in one or more data fields of the health record data, and cross-check the data to determine any logical inconsistencies. Examples of logical inconsistencies may include comparing a vaccination record with an individual's age (e.g., a measles, mumps, and rubella (MMR) vaccination is not given to a person 80-years-old), or the like. The data formatting error may comprise errors relating to the formatting of data in one or more health record data. For example, data formatting errors may comprise errors relating to missing data fields, grammatical errors, abbreviation errors (e.g., “street” vs. “st,” etc.), logical formatting errors (e.g., numerical values in name fields), or the like.

In various embodiments, method 401 may comprise monitoring the ingestion of health record data (step 402). Data quality system 140 may be configured to monitor the ingestion of health record data in health records management system 110. For example, monitoring module 260 of data quality system 140 may be configured to monitor the ingestion of health record data in health records management system 110. Data quality system 140 may monitor the ingestion of health record data to determine whether each received health record data comprises a data quality error, as described further above. In that respect, data quality system 140 may track the data quality errors to determine the number of ingested health record data that are causing data quality errors and/or the number of ingested health record data that are not causing data quality errors. In various embodiments, data quality system 140 may also track the type of data quality error that is occurring (e.g., data validation errors or data formatting errors).

In various embodiments, method 401 may comprise generating a data quality score (step 404). Data quality system 140 may be configured to generate the data quality score. For example, quality analysis module 270 of data quality system 140 may be configured to generate the data quality score. The data quality score may reflect the number of health record data ingested by health records management system 110 that comprise data quality errors, in comparison to the number of health record data ingest that do not comprise data quality errors. For example, in response to ingesting 900 health record data that cause no data quality errors and 100 health record data that cause data quality errors, data quality system 140 may generate a data quality score of 90%, or the like. The data quality score may comprise any suitable numerical, alpha-numerical, and/or similar such rating scale. In various embodiments, the data quality score may comprise the same rating scale as the data quality user threshold.

In various embodiments, method 401 may comprise comparing the data quality score to a data quality user threshold (step 406). Data quality system 140 may be configured to compare the data quality score to the data quality user threshold. For example, quality analysis module 270 of data quality system 140 may be configured to compare the data quality score to the data quality user threshold. Data quality system 140 may compare the data quality score to the data quality user threshold to determine whether the data quality score is greater than or less than the data quality user threshold. The data quality user threshold may be previously entered by a user, via user terminal 150, and stored in data quality system 140. A data quality score being greater than the data quality user threshold may indicate that the quality of health record data being ingested by system 100 may be greater than the threshold of quality set by the user. A data quality score being less than the data quality user threshold may indicate that the quality of health record data being ingested by system 100 is not meeting the threshold of quality set by the user. In various embodiments wherein the data quality score and the data quality user threshold comprise different rating scales, data quality system 140 may be configured to convert the data quality score and/or the data quality user threshold to a common rating scale prior to the step of comparing. Data quality system 140, via reporting module 290, may be configured to transmit the data quality score to user terminal 150.

In various embodiments, method 401 may comprise transmitting a data quality alert (step 408). Data quality system 140 may be configured to generate and transmit the data quality alert. For example, reporting module 290 of data quality system 140 may be configured to generate and transmit the data quality alert. In that regard, data quality system 140 may generate the data quality alert in response to the data quality score being less than the data quality user threshold. The data quality alert may comprise data indicating that the quality of health record data is not meeting the predetermined quality threshold set by the user (e.g., the data quality user threshold). Data quality system 140 may transmit the data quality alert using any suitable messaging platform, such as email systems, wireless communications systems, mobile communications systems, multimedia messaging service (“MMS”) systems, short messaging service (“SMS”) systems, and the like. Data quality system 140 may also transmit the data quality alert by displaying the data, via a GUI, webpage, or the like, for viewing by the user on user terminal 150.

In various embodiments, method 401 may comprise generating a data analytics report (step 410). Data quality system 140 may be configured to generate the data analytics report. For example, data analytics module 280 of data quality system 140 may be configured to generate the data analytics report. In that regard, data analytics module 280 may be configured with analytics capabilities to allow users (e.g., state representatives of the like) to visualize trending, provider referral details, and otherwise analyze the quality of health record data. Data analytics module 280 may also comprise and/or be configured with forecasting tools, for example in order to evaluate potential future immunization needs or other modeled public health requirements or outcomes related to the quality of the health record data being transmitted. Method 401 may comprise transmitting the data analytics report (step 412). Data quality system 140 may be configured to transmit the data analytics report to user terminal 150. For example, data analytics module 280 of data quality system 140 may be configured to transmit the data analytics report to user terminal 150. Data quality system 140 may transmit the data in response to a user request, or may transmit the data based on a processing schedule (e.g., daily, weekly, monthly, etc.). Data quality system 140 may transmit the data using any suitable messaging platform, such as email systems, wireless communications systems, mobile communications systems, multimedia messaging service (“MMS”) systems, short messaging service (“SMS”) systems, and the like. Data quality system 140 may also transmit the data by displaying the data, via a GUI, webpage, or the like, for viewing by the user on user terminal 150. For example, and with brief reference to FIG. 5C, an exemplary GUI 507 showing reported data analytics is depicted.

Systems, methods and computer program products are provided. In the detailed description herein, references to “various embodiments,” “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy,” “meet,” “match,” “associated with,” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate,” “associating,” or the like may include tagging, flagging, correlating, using a look-up table or any other method or system for indicating or creating a relationship between data elements. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

System 100 may comprise a distributed computing cluster. Distributed computing cluster may be, for example, a Hadoop® cluster configured to process and store data sets (e.g., health record data) with some of nodes comprising a distributed storage system and some of nodes comprising a distributed processing system. In that regard, distributed computing cluster may be configured to support a Hadoop® distributed file system (HDFS) as specified by the Apache Software Foundation at http://hadoop.apache.org/docs/.

Any communication, transmission and/or channel discussed herein may include any system or method for delivering content (e.g. health record data, data, information, metadata, etc.), and/or the content itself. The content may be presented in any form or medium, and in various embodiments, the content may be delivered electronically and/or capable of being presented electronically. For example, a channel may comprise a website or device (e.g., FACEBOOK®, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, etc.), an “ebook,” an “emagazine,” an application or microapplication (as described herein), an SMS or other type of text message, an email, Facebook®, Twitter®, MMS and/or other type of communication technology. In various embodiments, a channel may be hosted or provided by a data partner. In various embodiments, the distribution channel may comprise at least one of a state data source website, a healthcare provider website, a social media website, affiliate or partner websites, an external vendor, a mobile device communication, social media network and/or location based service. Distribution channels may include at least one of a healthcare provider website website, a social media site, affiliate or partner websites, an external vendor, and/or a mobile device communication. Examples of social media sites include FACEBOOK®, FOURSQUARE®, TWITTER®, MYSPACE®, LINKEDIN®, and the like. Moreover, examples of mobile device communications include texting, email, and mobile applications for smartphones.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include health record data, and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor in communication with a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. Implementation of the hardware so as to perform the functions described herein will be apparent to persons skilled in the relevant art(s).

In various embodiments, the server may include application servers (e.g. WEB SPHERE, WEB LOGIC, JBOSS, EDB® Postgres Plus Advanced Server® (PPAS), etc.). In various embodiments, the server may include web servers (e.g. APACHE, IIS, GWS, SUN JAVA® SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (“POS”) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS®/CE/Mobile, OS2, UNIX®, LINUX®, SOLARIS®, MacOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16 bit integers.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods. It is noted that the network may be implemented as other types of networks, such as an interactive television (ITV) network.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing.

Any databases discussed herein may include relational, hierarchical, graphical, blockchain, or object-oriented structure and/or any other database configurations. The databases may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), MongoDB®, Redis®, Apache Cassandra®, or any other suitable database product. Moreover, the databases may be organized in any suitable manner, for example, as data tables or lookup tables. Each record may be a single file, a series of files, a linked series of data fields or any other data structure.

The blockchain structure may include a distributed database that maintains a growing list of data records. The blockchain may provide enhanced security because each block may hold individual transactions and the results of any blockchain executables. Each block may contain a timestamp and a link to a previous block. Blocks may be linked because each block may include the hash of the prior block in the blockchain. The linked blocks form a chain, with only one successor block allowed to link to one other predecessor block.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using fixed storage allocation, circular queue techniques, or best practices with respect to memory management (e.g., paged memory, least recently used, etc.). By using BLOB methods, the ability to store various data sets that have different formats facilitates the storage of data, in the database or associated with system, by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may also be annotated in a standard manner. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the access levels. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PM, GPG (GnuPG), and symmetric and asymmetric cryptosystems.

The computing unit of the web client may be further equipped with an Internet browser connected to the Internet or an intranet using standard dial-up, cable, DSL or any other Internet protocol known in the art. Communications originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® Applets, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a method of communication, such as the internet. Web services are typically based on standards or protocols such as XML, SOAP, AJAX, WSDL and UDDI. Web services methods are well known in the art, and are covered in many standard texts.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE MQTM (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. Cryptography and network security methods are well known in the art, and are covered in many standard texts.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system for assessing health data quality, comprising:
a processor,
a tangible, non-transitory memory configured to communicate with the processor,
the tangible, non-transitory memory having instructions stored thereon that, in response to execution by the processor, cause the processor to perform operations comprising:
receiving, by the processor, an on-boarding request, wherein the on-boarding request comprises a data quality user threshold and a health record data source;
ingesting, by the processor, health record data from the health record data source;
monitoring, by the processor, the ingestion of health record data;
detecting, by the processor, a data quality error occurring during the ingestion of health record data; and
generating, by the processor, a data quality score based on the data quality error.

2. The system of claim 1, further comprising the operation of comparing, by the processor, the data quality score with the data quality user threshold.

3. The system of claim 1, further comprising the operation of generating, by the processor, a data analytics report based on at least one of the data quality error or the data quality score.

4. The system of claim 1, wherein the data quality error comprises at least one of a data validation error or a data formatting error.

5. The system of claim 4, wherein the data validation error is detected by comparing a first data field of the health record data to a second data field of the health record data based on a validation logic.

6. The system of claim 1, wherein the health record data source comprises at least one of a state health record data source or a healthcare provider system.

7. The system of claim 1, wherein the health record data comprises immunization records formatted according to Health Level 7 (HL7) messaging requirements.

8. A method of assessing and improving health data quality in an on-boarding environment, comprising:
receiving, by a health records management system, an on-boarding request, wherein the on-boarding request comprises a data quality user threshold and a health record data source;
ingesting, by the health records management system, health record data from the health record data source;
monitoring, by a data quality system in electronic communication with the health records management system, the ingestion of health record data to determine a data quality error occurring during the ingestion; and
generating, by the data quality system, a data quality score based on the data quality error, in response to determining the data quality error.

9. The method of claim 8, further comprising comparing, by the data quality system, the data quality score with the data quality user threshold.

10. The method of claim 8, further comprising generating, by the data quality system, a data analytics report based on at least one of the data quality error or the data quality score.

11. The method of claim 8, wherein the data quality error comprises at least one of a data validation error or a data formatting error.

12. The method of claim 11, wherein the data validation error is determined by comparing a first data field of the health record data to a second data field of the health record data based on a validation logic.

13. The method of claim 8, wherein the health record data source comprises at least one of a state health record data source or a healthcare provider system.

14. The method of claim 8, wherein the health record data comprises immunization records formatted according to Health Level 7 (HL7) messaging requirements.

15. A method of assessing and improving health data quality in a production environment, comprising:
monitoring, by a data quality system, an ingestion of health record data from a health record data source;
detecting, by the data quality system, a data quality error occurring during the ingestion of health record data; and
generating, by the data quality system, a data quality score based on the data quality error.

16. The method of claim 15, further comprising comparing, by the data quality system, the data quality score to a data quality user threshold.

17. The method of claim 16, further comprising generating, by the data quality system, a data quality alert in response to the data quality score being less than the data quality user threshold.

18. The method of claim 15, further comprising generating, by the data quality system, a data analytics report based on at least one of the data quality error, the data quality score, or the comparison of the data quality score to the data quality user threshold.

19. The method of claim 15, wherein the data quality error comprises at least one of a data validation error or a data formatting error.

20. The method of claim 15, wherein the health record data comprises immunization records formatted according to Health Level 7 (HL7) messaging requirements.
